(19) United States
(12) Patent Application Publication
(10) Pub. No.: US 2003/0071837 A1
(43) Pub. Date: Apr. 17, 2003

(54) System and method for explaining search logic and results

(75) Inventors: Douglas L. Sorensen, Hillsboro, OR (US); Clair Michael Bowman II, Beaverton, OR (US); David L. Goodwin, Portland, OR (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 09/943,404

(22) Filed: Aug. 30, 2001

(51) Int. Cl. G09G 5/00

(52) U.S. Cl. 345/705

(57) ABSTRACT

Systems and methods help explain search logic and search results to a user, who performed a search. The search is part of any application, such as email, word processing, e-commerce, database queries, Internet search engines, website searches, document management. Systems and methods of displaying similarity profiles and manipulating the profile of a relevancy search help a user to understand how a search is performed and why the results are what they are. In this way, a user learns more quickly and searches more efficiently.

### BACKGROUND

In the information age, there is a malaise known as information overload, infoglut, infobog, and datasmog. The twin demons of speed and quantity create an artificial sense of urgency with email, voice mail, fax, and the web. Continuous streams of data are possible 24-hours a day, at work, at home, and during the commute in between. Some say that there is just too much information. Others say the problem is the proliferation of communication channels for distributing and accessing information, such as email, faxes, spreadsheets, presentations, browsers, applications, websites, and data warehouses. Still others say that it is not too much information but an explosion of non-information lacking relevance, quality, and usefulness. What good is all this information if it is not usable?

To operate in Internet time, it is very important to get the right information to the right people at the right time. Knowledge workers confronted with information overload need ways to improve decision-making, productivity, and effectiveness. Substandard performance, incorrect decisions, and repeatedly reinventing the wheel are some of the consequences of knowledge workers not having needed information when they need it. Today, many businesses are concerned about knowledge management.

Francis Bacon said “Knowledge is power.” To become power, information must be integrated, applied and transformed into knowledge by the human mind. Albert Einstein said “Imagination is more important than knowledge.” People may perceive information overload when information they receive does not fit their mental models (in their imagination) for understanding the world. Information is data organized into meaningful context, while knowledge is organized data that has been understood and applied.

Computers tend to over-index, excluding little without filtering, grading, ranking, reviewing, annotating, or repackaging information. They also tend to categorize information differently than people do, often providing uniform and equal access to everything. They tend to neither facilitate understanding nor make information accessible and comprehensible. They do not tend to help people make decisions by converting data into information and information into insight.

Thus, there is a need for tools and techniques to bridge the gap between how humans use information and how computers provide it. If a product is intuitive—so that a user can look at a thing and see how it works—then the knowledge is in the product or feature itself. On the other hand, if a user has to read a manual or instruction sheet and memorize a number of arbitrary facts in order to use a product or feature, then the knowledge is in the user's head instead. There is a need, therefore, for computer products which provide visibility, mapping, feedback, and mental models to put more of the knowledge in the product so less needs to be in the user's head.

### BRIEF DESCRIPTION OF THE DRAWINGS

FIG. 1 is a block diagram showing an example working environment for embodiments of the present invention.

FIG. 2 is a block diagram showing an example computer system for various embodiments of the present invention. In one embodiment, the computer system operates in the example working environment shown in FIG. 1.

FIG. 3 is a block diagram showing an embodiment of a computer system for explaining search logic and results. In one embodiment, the computer system is similar to the example computer system of FIG. 2.

FIG. 4 is a block diagram showing a conceptual view of an explanation of search logic and results.

FIG. 5 is a block diagram of an embodiment of a user interface for explaining search logic and results.

FIG. 6 is a flow chart of an embodiment of a method for explaining search logic and results.

FIG. 7 is an example of a user interface, which is more detailed than the user interface of FIG. 5.

### DETAILED DESCRIPTION

The present invention comprises systems and methods for explaining search logic and results. In the following detailed description, reference is made to the accompanying drawings which form a part hereof. These drawings show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

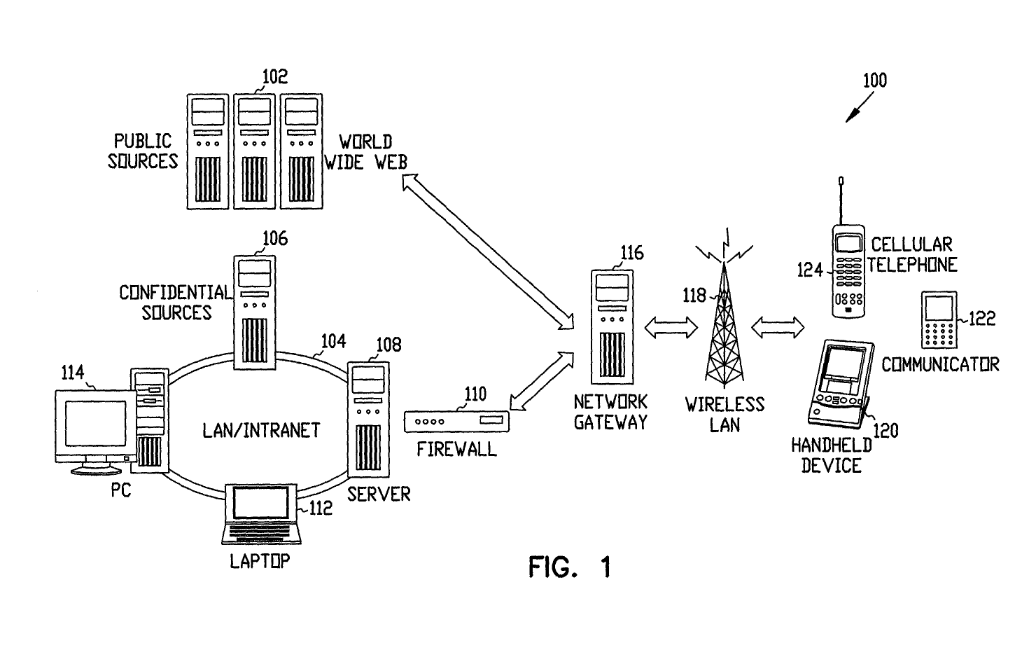

FIG. 1 is a block diagram showing an example working environment 100 for embodiments of the present invention. The example working environment 100 comprises public sources of information and the World Wide Web 102, local area networks (LANs) or Intranets 104, confidential sources of information 106, server computers 108, firewalls 110, laptops, 112, personal computers (PCs) 114, network gateways 116, such as wireless application protocol (WAP) gateways, wireless LANs 118, handheld devices 120, such as personal digital assistants (PDAs), communicators 122, and cellular telephones 124. The example working environment allows users to download new applications, such as MP3 digital music decoders, to their mobile handsets, discover new services as they roam, and interact with their desktop computers while they move untethered about their workplace. The wireless Internet environment supports multimedia services, fixed or mobile networks, cable, xDSL, wireless LAN, digital broadcast, IMT 2000 radio access technologies, and media gateway controllers, among other things.

The example working environment is only one example of a suitable working environment and is not intended to suggest any limitation as to the scope of use or functionality of various embodiments of the invention. Other example working environments include, but are not limited to, simple speech-only terminals, multimedia terminals, multiprocessor systems, microprocessor systems, set top boxes, programmable consumer electronics, electronic appliances, network PCs, minicomputers, mainframe computers, personal area networks (PANs), and distributed computing environments that include any of the above components or the like. Example working environments support micro-browsers, operating systems, markup languages, protocols, middleware, applications, such as word processing, email, and the like.

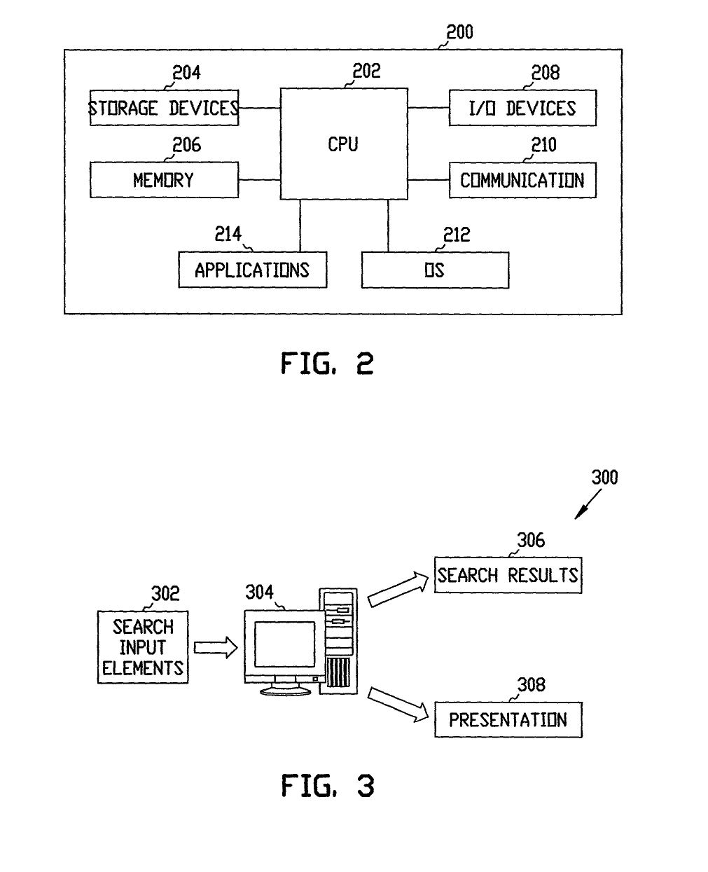

FIG. 2 is a block diagram showing an example computer system 200 for various embodiments of the present invention. In one embodiment, the computer system operates in the example working environment shown in FIG. 1. The example computer system 200 comprises a central processing unit (CPU) 202, storage devices 204, memory 206, input/output (I/O) devices 208, communications 210, an operating system 212, and applications 214. The example computer system 200 is not limited to these components and may include other components. The invention operates with computer systems other than the example computer system 200. The components of the example computer system may also be combined in various ways, such as combining some storage devices 204 with memory 206. One or more buses couple various system components, such as a bus that couples memory to the CPU. The bus is any way of transferring data and control among components of the example computer system and has any type of architecture. The CPU 202 is any general purpose computing device that interprets and executes instructions, such as a microprocessor.

The storage devices 204 is any way of recording data in permanent or semi-permanent form, including volatile and nonvolatile memory. Some examples of storage devices 204 are random access memory (RAM), read-only memory (ROM), disk drives, floppy disks, hard disks, tape, optical discs, electrically erasable programmable read-only memory (EEPROM), programmable read-only memory (PROM), flash memory, flash cards, form factor memories, low power hard disks, bubble memory, mass storage, and other memory technologies, compact disc read-only memory (CD-ROM), digital versatile disks (DVD), and other optical disk storage, magnetic cassettes, magnetic tape, magnetic disk storage and other magnetic storage devices, and any other storage medium accessible by a computing device.

The memory 206 is any way of storing and retrieving data, including volatile and nonvolatile media, removable and non-removable media, storage media, communications media, and the like.

The input/output (I/O) devices 208 are any way of providing input and output to the example computer system 200. Some examples of input devices are keyboards, mice, trackball, joysticks, styluses, touch pads, microphones, game pads, satellite dishes, and scanners. Some examples of output devices are printers, screens, monitors, files, network communications lines, speakers, and video. Some devices serve as both input and output devices. I/O devices 208 are connected to the CPU 202 by interfaces.

Communications 210 are any way of delivering information. Some examples of communications are machine-accessible instructions, data structures, program modules, data in a modulated data signal, such as a carrier wave or other transport mechanism. A modulated data signal is a signal that has one or more of its characteristics set or changed to encode information in the signal.

The applications 214 are any programs designed to perform functions, methods, or tasks, such as word processing, and email. Programs are sequences of instructions that are loadable into memory 206 and executable by the CPU 202. Some applications are part of the operating system (OS) 212 and some are not.

The operating system (OS) 212 is any way of managing applications 214 and controlling allocation and usage of resources, such as CPU 202 time, storage devices 204, memory 206, I/O devices 208, and communications 210. Some examples of operating systems are Windows, Mac OS, UNIX, VMS, Linux, and Palm OS.

Various embodiments of the invention are described as machine-accessible mediums having associated content capable of directing a machine to perform a method, such as applications and program modules. Generally, such methods include instructions, routines, programs, objects, components, data structures and the like to perform procedures, functions, and tasks using data. Embodiments of the invention are also practiced in distributed computing environments where instructions are performed remotely over a communications network. Embodiments of the invention may be practiced with any computer system now existing or in the future.

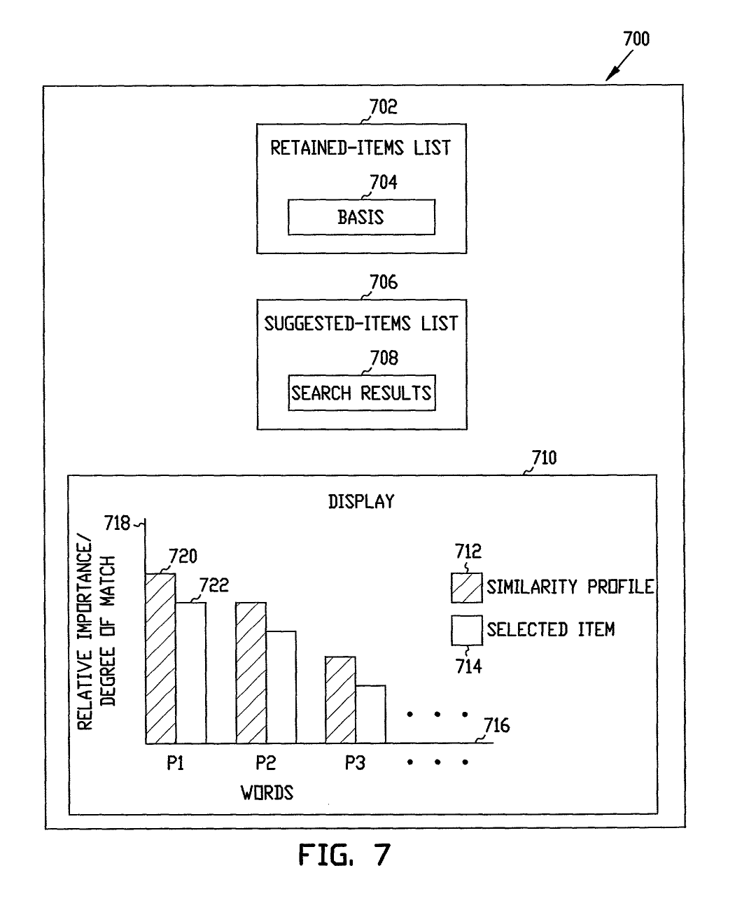

FIG. 3 is a block diagram showing an embodiment of a computer system 300 for explaining search logic and results. In one embodiment, the computer system 300 is similar to the example computer system 200 of FIG. 2. (For examples of how the computer system 300 in FIG. 3 is used, see FIGS. 6 and 7.) The computer system 300 takes search input elements 302 as input to a computer 304 and produces search results 306, and a presentation 308. Search input elements 302 are any way of communicating what a user is seeking to find, such as words, documents, speech, images, signals, graphical data, or any other kind of data or information. The computer system 300 has a search component and a presentation component. The search component accepts at least one search input element and determines at least one search result using a system model. A system model is a collection of data and control concepts used in the software running on the computing device, such as a search profile. The presentation component creates a presentation 308 of a presentation model relating the system model to one of the search results 306. The presentation model is a way of envisioning the process of executing the search, which is how the computing device does the search, how the user conceptualizes the search, or some combination in between the two. The presentation 308 is any way of explaining search logic and results to the user. Examples of presentations 308 are charts, diagrams, graphs, tables, guides, instructions, directories, and maps. The presentation 308 is any way of communicating with the user by way of images, words, numbers, and the like. The computer 304 performs the desired search by any way of finding information, such as by executing a search engine. Alternatively, the computer 304 performs the search as part of some other application, such as a database program. Some other examples of applications using searches are e-commerce, library catalogs, operating systems, email programs, and web sites.

For example, a user may select one or more documents as search input elements 302 as part of a search request. The computer system 300 takes the input documents and produces a list of similar, relevant documents as search results 306 using the system model. The list of similar, relevant documents is part of the presentation 308 on a computer display. The computer system produces a presentation model explaining how the search input elements lead to the search results by way of a list of key words selected from the input documents ranked in order of importance and frequencies of how often the key words appeared in both the input documents and the resulting documents. The presentation model also has words from the input documents that were not used in producing the results. The presentation 308 is a computer display showing the presentation model to the user in a manner that facilitates understanding. The presentation 308 allows the user to view the input documents and resulting documents with the key words highlighted. In this way, the user has visibility into the inner workings of the search, which permits the user to be more efficient and intelligent in conducting searches.

One aspect of the present invention is a machine, such as a computer system for explaining search logic and results 300, which comprises a processor, a storage device coupled to the processor, a search component, and a presentation component. The processor is any type of processor, such as a central processing unit (CPU), a microprocessor or any kind of programmable logic. In one embodiment, the processor is a server which is capable of receiving the at least one search input element 302 from a client. In another embodiment, the processor is capable of communicating in a wireless Internet environment. The search and presentation components are storable on the storage device and executable on the processor, such as machine-accessible instructions, program modules, and data. The search component accepts at least one search input element 302 and determines at least one search result 306 using a system model. In some embodiments, the search component is part of a search engine; in others, the search component is part of any other type of application. The presentation component creates a presentation 308 of a presentation model relating the system model to one of the search results 306. The presentation 308 is any kind of presentation of data to the user, such as a screen on a monitor of a PC, video on a television screen, or voice information over a telephone.

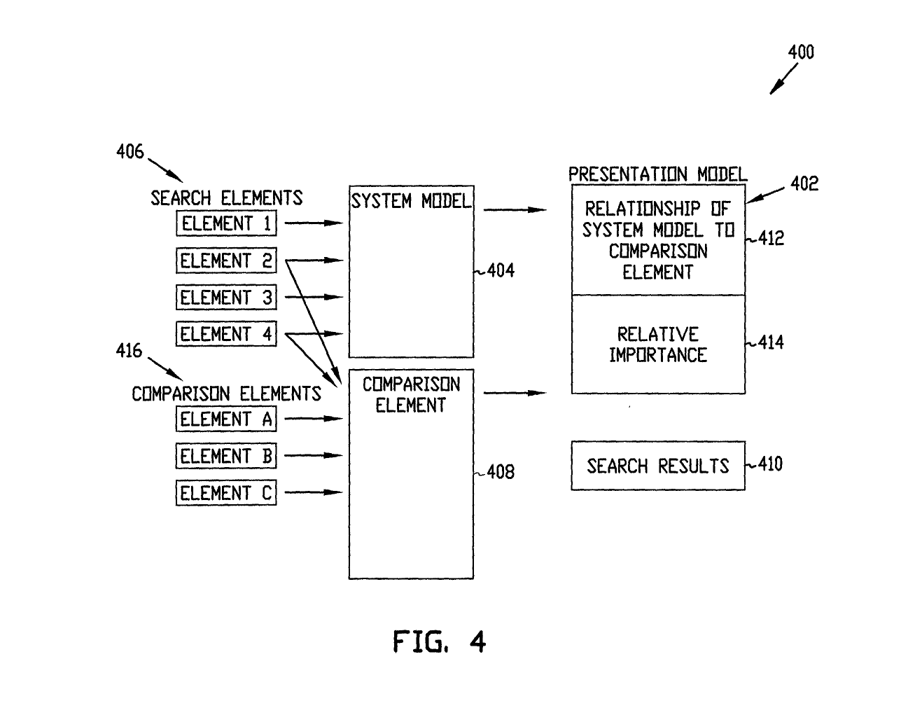

FIG. 4 is a block diagram showing a conceptual view 400 of an explanation of search logic and results. The conceptual view 400 illustrates elements of a presentation that lead a user to understand how a search works. One aspect of the present invention is a method for explaining search logic and results which comprises presenting a presentation model 402. The presentation model 402 explains how a system model 404 relates a plurality of search input elements 406 to a comparison element 408. The comparison element 408 may be selected from a number of potential comparison elements 416. The system model 404 determines at least one search result 410, which, in one embodiment, can be saved for later repeating the search. The method also comprises presenting how the system model 404 is related to the comparison element 408. This is shown in FIG. 4 as the relationship of the system model to the comparison element 412. The method also comprises presenting a relative importance 414 of the system model 404 in comparison with the comparison element 408. In one embodiment, the method further comprises presenting how parts of the system model 404 are related 412 to parts of the comparison element 408. In another embodiment, the method further comprises presenting a relative importance 414 of the parts of the system model 404 in comparison with parts of the comparison element 408. In another embodiment, the method further comprises presenting how parts of each of the plurality of search input elements 406 are related to parts of the system model 404. In another embodiment, the method further comprises presenting a relative importance 414 of the parts of the plurality of search input elements 406 in comparison with the parts of the system model 404. In this way, the level of granularity of the presentation model 402 may be coarse or fine.

For example, if the search input elements 406 are HTML documents, the parts are words, images, links, and the like. In this example, the system model 404 and the presentation model 402 would have parts which are also words, images, links, and the like, but need not be the same parts. An example presentation model 402 is a textual description displayed on a computer display relating input key words to resulting documents and explaining the search logic and how the results were determined. Also, the computer display lists the key words used to process the search in order of how similar and relevant they are to the results. The example computer display has hotlinks or hyperlinks on the keywords in the textual description that point to input documents and resulting documents.

In some embodiments, the presentation model 402 includes mapping, good visibility, affordances, feedback, mental models, and the like. A mapping is part of the presentation model 402 that shows, directly or indirectly, the relationship of the system model to the comparison element 412. The presentation model 402 illustrates a cause and effect relationship between a user action and the search results 410. For example, a user adds or deletes a search element 406 and notices a change in search results 410. The system model 404 and the presentation model 402 are updated dynamically or periodically, such as after one or more user actions. Good visibility is a property of the presentation model 402, so that a user can glance at the presentation model 402 and tell what it did, what state it is in, and what actions are possible. Affordances are part of the presentation model 402 that tell the user, visually or otherwise, what parts of the presentation model 402 do and how the search works. Feedback is part of the presentation model 402 that returns information to the user about what the user just did. Feedback is visual, auditory, tactile, or any other way of presenting useful information to the user about an action. Mental models are part of the presentation model 402 that reflect what the user knows about the search, including providing context for the search within an application. For example, the presentation model 402 provides metaphors and appropriate visual cues that mimic the function or task as it is performed by the user in the real world.

In one embodiment, the method comprises receiving a modification to the plurality of search input elements 406 to create a new plurality of search input elements. A new search result is determined and the system model 404 is updated to create a new system model incorporating the modification. The method comprises presenting how the new system model is related to the comparison element 408 and presenting a new relative importance of the new system model in comparison with the comparison element 408.

Another aspect of the present invention is a machine-accessible medium having machine-accessible instructions for performing a method of explaining search logic and results. The method comprises performing an application, presenting a presentation model 402, presenting a contribution, and presenting a relative importance 414. Performing an application comprises accepting at least one search input element 406 and producing at least one search result 410 using a system model 404. The application performed by the method has search logic and is one of many different kinds of applications. In one embodiment, the application is an electronic mail application. In other embodiments, the application is an Internet search engine, a database application, an e-commerce application, or a document management application. Presenting a presentation model 402 comprises explaining how the system model relates the at least one search input element 406 to a comparison element 408. Presenting a contribution comprises presenting a contribution of the comparison element 408 to the system model 404. Presenting a relative importance 414 comprises presenting a relative importance 414 of the system model 404 in comparison with the comparison element 408.

In another embodiment of the machine-accessible medium having machine-accessible instructions for performing the method of explaining search logic and results, the method further comprises presenting a contribution of parts of the comparison element 408 to parts of the system model 404 and presenting a relative importance 414 of parts of the system model in comparison with parts of the comparison element 408. Showing the user how parts are related as well as how wholes are related help the user to understand the search logic and results.

In another embodiment, the method further comprises accepting at least one modification to the at least one search input element 406, dynamically updating the system model 404 and the presentation model 402, dynamically updating the contribution, and dynamically updating the relative importance 414. Dynamically updating means re-presenting the presentation to the user after an action by the user, such as adding or deleting a search element. This dynamic updating is done substantially in real-time. Dynamically updating the system model 404 and presentation model 402 includes updating how the at least one search input element 406 is related 412 to the at least one search result 410. Dynamically updating the contribution comprises updating the contribution of the comparison element 408 to the system model 404. Dynamically updating the relative importance 414 comprises updating the relative importance 414 of the system model 404 in comparison with the comparison element.

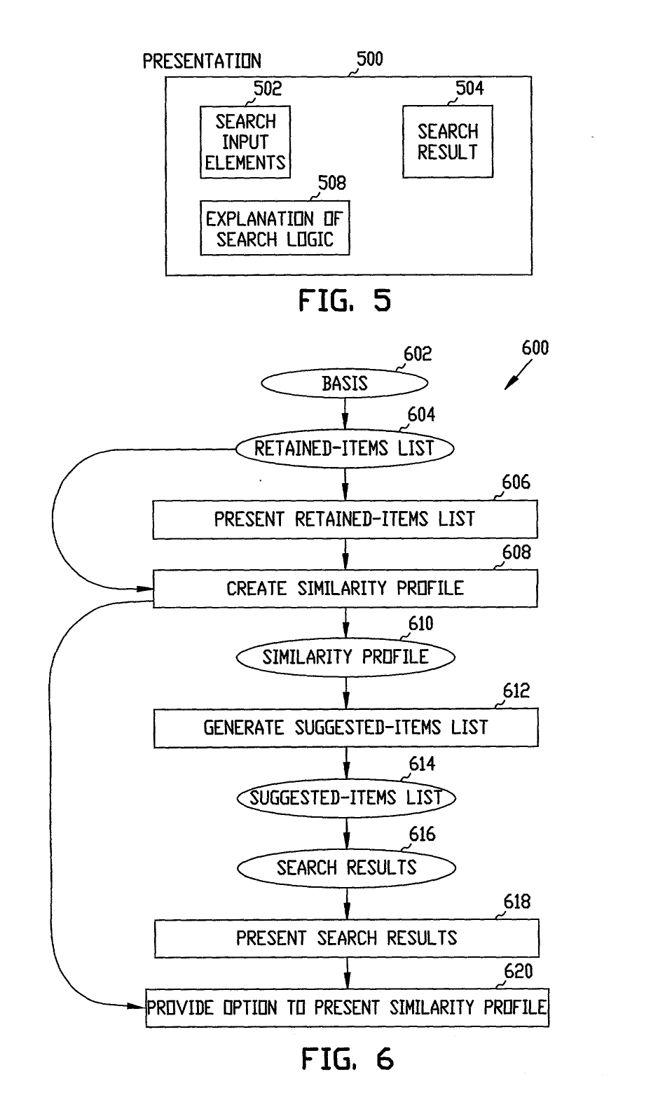

FIG. 5 is a block diagram of an embodiment of a user interface 500 for explaining search logic and results. The user interface 500 is that portion of the program that interacts with the user and the interactions take many forms, such as graphical, visual, auditory, and the like. One aspect of the present invention is a user interface 500, which comprises receiving at least one search input element 502, presenting at least one search result 504 using a system model, and presenting an explanation of search logic 508. In one embodiment, presenting an explanation of search logic comprises presenting a presentation model to explain how a comparison element is related to a system model. In another embodiment, the user interface 500 further comprises presenting a relative importance of the comparison element to the system model. In another embodiment, the user interface 500 further comprises receiving at least one modification to the at least one search input element 502 and dynamically updating the explanation of search logic 508.

FIG. 6 is a flow chart of an embodiment of a method 600 for explaining search logic and results. In FIG. 6, data is shown in ovals and control is shown in boxes. One aspect of the present invention is a method 600 for explaining search logic and results, which comprises receiving a basis 602, presenting the basis 604, 606, creating a similarity profile 608, 610, generating a suggested-items list 612, 614, presenting the suggested-items list 616, 618, and providing an option for presentation of the similarity profile 620. Receiving a basis 602 comprises receiving the basis 602 of a search. The basis 602 comprises at least one item and is made up of search input elements. For example, the basis is a document or documents used to create a profile and do a search. After the search has been performed, the basis 602 is placed in a retained-items list 604. The user can add or remove documents from this list as they wish. When this is done, the search profile is updated. The user can leave a document in the retained list but not have it contribute to the profile, if they desire. In the example, the retained-items list 604 is a list of documents chosen to start a search, but the list can be added to and modified to refine the search. The similarity profile 610 is created 608 from the retained-items list 604. As soon as the retained item list is created, the user can view the similarity profile with the comparison element coming from the retained list. As another option, the user can view the similarity profile with the comparison element coming from the suggestion list. Another option is to have the comparison element come from a completely different collection or source. The similarity profile 610 is an example of a system model 402, which is shown in FIG. 4. For example, the similarity profile 610 is a bar graph relating the search input elements in the basis 602 to the search results 616. The suggested-items list 614 is generated 612 from the retained items list 604 and comprises at least one item. For example, the suggest-items list 614 is a list of resulting documents from the search displayed on a computer display. The suggested-items list 614 is an example of search results 616, like the search results 410 shown in FIG. 4.

In one embodiment, the method further comprises receiving a selected item from the suggested-items list 614, receiving a request for presentation of the similarity profile 610 for the selected item, and presenting a presentation comparing the selected item to the similarity profile 610.

Another embodiment involves a search where the search input elements are made up of words. In this embodiment, the presenting the presentation comparing the selected item to the similarity profile 610 comprises computing a profile-word importance, computing a degree of match, presenting the profile-word importance and the degree of match. A profile-word importance is computed for each word in the similarity profile 610. A degree of match is computed for each word in the selected item in relation to the similarity profile 610 using the profile-word importance. The profile-word importance is presented for each word in the similarity profile 610. The degree of match is presented for each word in the selected item in relation to that same word in the similarity profile 610.

### EXAMPLE EMBODIMENT

FIG. 7 is an example of a user interface 700, which is more detailed than the user interface 500 of FIG. 5. The user interface 700 comprises a retained-items list 702 containing search input elements forming a basis 704 used to start a search. Also, in the user interface 700 is a suggested-items list 706 containing the search results 708. To help explain how the search results 708 were created from the basis 704, a display 710 shows how a selected item 714 from the basis 704 contributed to the similarity profile 712. The example user interface 700 in FIG. 7 shows a bar chart with a legend indicating which bars form the similarity profile 712 and which bars form the selected item 714. The similarity profile 712 comprises the bars 720 filled with diagonal lines and the selected item 714 comprises the bars 722 with no lines. The bar chart measures on the y-axis the importance 718 to the similarity profile 712 of the parts 716 on the x-axis of the selected item 714 and shows for each of the same parts 716 the degree of match with the selected item 714. The vertical axis measures importance 718 only for the similarity profile 712 whereas the degree of match of the selected item 714 with the similarity profile 712 is not measured directly on the y-axis, but is understood by comparing the heights of pairs of similarity profile 712 and selected items 714 bars.

The user interface 700 in FIG. 7 is a specific, concrete example of the conceptual view 400 of explaining search logic and results in FIG. 4. Comparing FIG. 7 to FIG. 4, the basis 704 in FIG. 7 is an example of search input elements 406 in FIG. 4; the display 710 in FIG. 7 is an example of the presentation model 402 in FIG. 4; the similarity profile 712 in FIG. 7 is an example of the system model 404 in FIG. 4; the selected item 714 in FIG. 7 is an example of the comparison element 408 in FIG. 4; and the search results 708 in FIG. 7 are an example of the search results 410 in FIG. 4. The ordering of bars in the bar graph of display 710 in FIG. 7 is an example of the relative importance 414 in FIG. 4. The pairing of similarity profile bars 720 and selected item bars 722 in the bar graph of display 710 in FIG. 7 is an example of the relationship of system model to comparison element 412 in FIG. 4. There are many other ways of presenting this information.

In an example embodiment, relevancy searches are done by providing words or by providing example documents as the basis 704 to get a suggested-items list 706 containing a list of documents as search results 708. The similarity profile 712 is a sequence of important words culled from the basis. The user selects a document from the search results 708 as the selected item 714 and compares it to the similarity profile 712 to get an idea of how it contributed to the results. Then, the user can decide quickly whether to keep or remove the selected item 714 from the basis 704 and learn how to do a better search next time. Without the example embodiment, a user would learn to search through trial and error and understanding the contribution of any one document or word would be difficult. The example embodiment provides a tool and mechanism for manipulating a similarity profile 712. This improves the quality of the search results and provides a context for the user to understand how the search is done.

In the display 710 of FIG. 7, the most important words (P1, P2, P3 . . . ) in the similarity profile 712 are ordered along the x-axis 816 in descending order of importance. Each word has two values associated with it: (1) the word's contribution to the profile 720 and (2) the word's contribution to the currently selected item 722. When the mouse hovers over any bar of the graph, the word associated with that bar is displayed. When a different document in the suggested-items list 706 is selected, the graph updates dynamically. When a document is added or removed from the basis 704, the similarity profile 712 dynamically updates to show the changes.

The example embodiment has many advantages. The user dynamically adds and removes examples from the similarity profile 712, sees the similarity profile 712 at a glance, sees any particular document's (selected item's 714) contribution to the similarity profile 712, and sees how a particular word (P1, P2, P3 . . . ) contributes to the similarity profile 712. By seeing the retained items list 702, the suggested-items list 706, and the display 710, the user understands how the search is done. This understanding allows the user to make better inferences regarding the effect of adding any particular document to the basis 704. Instead of learning to use the product by extensive trial and error, the user can make informed changes to the basis 704 and quickly come to an understanding via an accurate mental model of the product.

In the example embodiment, profile and document contribution scores for each word are based on the cosine relevance score, a standard vector space relevance metric. Bounded by zero and one, this score measures the degree to which a document 714 matches a similarity profile 712. That is, this score measures the degree to which the word scores in a document 714 match those in a similarity profile 712. The word score is corrected for document length. The equation used to compute a relevance score is:

$$relevance = \frac{{\sum }_{i} {P}_{i} {D}_{i}}{\sqrt{{\sum }_{i} {P}_{i}^{2}} \sqrt{{\sum }_{i} {D}_{i}^{2}}} \qquad ( 1 )$$

where Pᵢ and Dᵢ are the similarity profile 712 and document scores for word i. The contribution of a single word j to the relevance score is:

$$contribution = \frac{{P}_{j} {D}_{j}}{\sqrt{{\sum }_{i} {P}_{i}^{2}} \sqrt{{\sum }_{i} {D}_{i}^{2}}} \qquad ( 2 )$$

If the similarity profile 712 is substituted for the document, we obtain a measure of word j's importance 718 in the similarity profile 712:

$$profile word importance = \frac{{P}_{j}^{2}}{{\sum }_{i} {P}_{i}^{2}} \qquad ( 3 )$$

This is the score that is used for each word's contribution to the similarity profile 712. To measure how well word j in the document matches the similarity profile 712 equation (2) is rewritten as:

$$degree of match = ( \frac{{D}_{j}}{\sqrt{{\sum }_{i} {D}_{i}^{2}}} / \frac{{P}_{j}}{\sqrt{{\sum }_{i} {P}_{i}^{2}}} ) \frac{{P}_{j}^{2}}{{\sum }_{i} {P}_{i}^{2}} \qquad ( 4 )$$

The degree of match is the importance 716 of word j weighted by a document-to-similarity-profile relative importance measure. If this weight is less than one, (i.e. the word is relatively less important in the document 714 than in the similarity profile 712), then equation (4) is used for each word's contribution to the search profile. If the weight is greater than one (i.e., if the word is relatively more important in the document 714 than in the similarity profile 712), the weight is inverted:

$$degree of match = ( \frac{{P}_{j}^{2}}{\sqrt{{\sum }_{i} {P}_{i}^{2}}} / \frac{{D}_{j}}{\sqrt{{\sum }_{i} {D}_{i}^{2}}} ) \frac{{P}_{j}^{2}}{{\sum }_{i} {P}_{i}^{2}} \qquad ( 5 )$$

Thus, the comparison of a word's degree of match (equations (4)(5)) to its profile word importance (equation (3)) shows how well the word in the selected item 714 matches the same word in the similarity profile 712, whether the word is more or less important in the selected item 714. In FIG. 7, a bar for the selected item 722 is never taller than its paired similarity profile bar 720. If a word is of identical importance in the selected item 714 and the similarity profile 712, then the corresponding bars 720 and 722 are of identical height.

It is to be understood that the above description it is intended to be illustrative, and not restrictive. Many other embodiments will be apparent to those skilled in the art, upon reviewing the above description. The scope of the invention should, therefore, be determined with reference to the appended claims, along with the full scope of equivalents to which such claims are entitled.

What is claimed is:

1. A method for explaining search logic and results, comprising:
presenting a presentation model to explain how a system model relates a plurality of search input elements to a comparison element, wherein the system model is used to determine at least one search result;
presenting how the system model is related to the comparison element; and
presenting a relative importance of the system model in comparison with the comparison element.

2. The method as recited in claim 1, further comprising:
presenting how parts of the system model are related to parts of the comparison element.

3. The method as recited in claim 2, further comprising:
presenting a relative importance of the parts of the system model in comparison with parts of the comparison element.

4. The method as recited in claim 2, further comprising:
presenting how parts of each of the plurality of search input elements are related to parts of the system model.

5. The method as recited in claim 4, further comprising:
presenting a relative importance of the parts of the plurality of search input elements in comparison with the parts of the system model.

6. The method as recited in claim 1, further comprising:
saving the system model.

7. The method as recited in claim 1, further comprising:
receiving a modification to the plurality of search input elements to create a new plurality of search input elements;
determining a new at least one search result;
updating the system model to create a new system model incorporating the modification;
presenting how the new system model is related to the comparison element; and
presenting a new relative importance of the new system model in comparison with the comparison element.

8. A machine for explaining search logic and results, comprising:
a processor;
a storage device coupled to the processor;
a search component storable on the storage device and executable on the processor to accept at least one search input element and determine at least one search result using a system model; and
a presentation component storable on the storage device and executable on the processor to create a presentation of a presentation model relating the system model to one of the at least one search result.

9. The machine as recited in claim 8, wherein:
the processor is a server; and
further wherein the processor is capable of receiving the at least one search input element from a client.

10. The machine as recited in claim 8, wherein the processor is capable of communicating in a wireless Internet environment.

11. A machine-accessible medium having associated content capable of directing the machine to perform a method of explaining search logic and results, the method comprising:
performing an application to accept at least one search input element and to produce at least one search result using a system model, the application having search logic;
presenting a presentation model to explain how the system model relates the at least one search input element to a comparison element;
presenting a contribution of the comparison element to the system model; and
presenting a relative importance of the system model in comparison with the comparison element.

12. The machine-accessible medium as recited in claim 11, further comprising:
presenting a contribution of parts of the comparison element to parts of the system model; and
presenting a relative importance of parts of the system model in comparison with parts of the comparison element.

13. The machine-accessible medium as recited in claim 11, further comprising:
accepting at least one modification to the at least one search input element;
dynamically updating the system model and the presentation model;
dynamically updating the contribution of each of the comparison element to the system model; and
dynamically updating the relative importance of the system model in comparison with the comparison element.

14. The machine-accessible medium as recited in claim 11, wherein the application is an electronic mail application.

15. The machine-accessible medium as recited in claim 11, wherein the application is an Internet search engine.

16. The machine-accessible medium as recited in claim 11, wherein the application is a database application.

17. The machine-accessible medium as recited in claim 11, wherein the application is an e-commerce application.

18. The machine-accessible medium as recited in claim 11, wherein the application is a document management application.

19. A user interface, comprising:
receiving at least one search input element;
presenting at least one search result using a system model; and
presenting an explanation of search logic.

20. The user interface as recited in claim 19, wherein presenting an explanation of search logic comprises:
presenting a presentation model to explain how a comparison element is related to a system model.

21. The user interface as recited in claim 20, further comprising:
presenting a relative importance of the comparison element to the system model.

22. The user interface as recited in claim 21, further comprising:
receiving at least one modification to the at least one search input element; and
dynamically updating the explanation of search logic.

23. A method for explaining search logic and results, comprising:
receiving a basis of a search, the basis comprising at least one item;
presenting the basis in a retained-items list;
creating a similarity profile from the retained-items list;
generating a suggested-items list from the similarity profile, the suggested-items list comprising at least one item;
presenting the suggested-items list as search results; and
providing an option to present the similarity profile.

24. The method as recited in claim 23, further comprising:
receiving a selected item from the suggested-items list;
receiving a request for presentation of the similarity profile for the selected item; and
presenting a presentation comparing the selected item to the similarity profile.

25. The method as recited in claim 24, wherein presenting the presentation comparing the selected item to the similarity profile comprises:
computing a profile-word importance for each word in the similarity profile;
computing a degree of match for each word in the selected item in relation to the similarity profile using the profile-word importance;
presenting the profile-word importance for each word in the similarity profile; and
presenting the degree of match for each word in the selected item in relation to that same word in the similarity profile.
